(19) United States
(12) Patent Application Publication
(10) Pub. No.: US 2026/0065326 A1
(43) Pub. Date: Mar. 5, 2026

(54) USING LARGE LANGUAGE MACHINE-LEARNING MODEL FOR CHECKING FLYER QUALITY ASSURANCE

(71) Applicant: Maplebear Inc., San Francisco, CA (US)

(72) Inventors: Shaun Navin Maharaj, Vaughan (CA); Bryan Pham, London (CA); Rakshit Shukla, Mississauga (CA); Bryan Mierdel, Holland Landing (CA)

(21) Appl. No.: 18/821,015

(22) Filed: Aug. 30, 2024

(51) Int. Cl. G06Q 30/0241; G06F 3/0484; G06F 40/205; G06F 40/279; G06N 3/0475; G06T 11/60; G06V 10/26; G06V 30/148; G06V 30/19

(52) U.S. Cl. CPC G06Q 30/0276; G06F 40/205; G06F 40/279; G06N 3/0475; G06T 11/60; G06V 10/26; G06V 30/153; G06V 30/19; G06F 3/0484

(57) ABSTRACT

An online system performs flyer quality assurance monitoring to identify and remedy errors in flyers. The online system generates a prompt for a large language machine-learning model (LLM) to verify the flyer's accuracy. The prompt includes a portion of the flyer and a query to identify errors in that portion. The online system provides the prompt to a model serving system for execution by the LLM. The online system receives, from the model serving system, a response indicating error(s) identified in the portion of the flyer. Responsive to receiving identifying the errors, the online system performs remedial measure(s) to correct the identified error(s). Remedial measures may include correcting associations to items in an item catalog, modifying textual information or image data in the flyer, etc. The online system transmits the corrected flyer to client device(s) for presentation to user(s) of the online system.

### BACKGROUND

An online system is an online platform that connects users and retailers. A user can place an order for obtaining items, such as groceries, from participating retailers via the online system, with the shopping being done by a picker. After the picker finishes shopping, the order is delivered to the user's address. Oftentimes, a retailer distributes flyers, which advertise one or more items and provide information about the sale of those items to users of the online system.

Typically, stores create periodic flyers to drive traffic. These flyers may be digitally-interactable flyers, such that a user viewing the flyer can engage (e.g., order, add to a list, favorite, redeem a coupon) with items displayed in the flyer and associated by the online system. However, such flyers are prone to error. Example errors include inaccurate association or tagging of items in the item catalog with display elements in the flyer. Other example errors may include inconsistencies between text information describing a promoted item and the images illustrating the promoted items. Further areas of improvement include missed inclusion of items that relate to a promotion. Such errors amount to technical problems in the implementation and dissemination of flyers.

### SUMMARY

An online system is an online platform that connects users and retailers. A requesting user can place an order for obtaining items, such as groceries, from participating fulfillment locations via the online system, with the item obtainment performed by a fulfillment user. After the fulfillment user completes item obtainment, the order with the obtained items may be delivered to a pre-specified location. In conjunction with fulfilling such orders, the online system may present flyers received from stores, promoting various items. Prior to presentation, the online system may perform flyer quality assurance (QA) monitoring to identify and remedy errors in the flyers.

To perform flyer QA monitoring, the online system generates a prompt for a large language machine-learning model (LLM) to verify the flyer's accuracy. The prompt includes a portion of the flyer and a query to identify errors in that portion. The online system provides the prompt to a model serving system for execution by the LLM. The online system receives, from the model serving system, a response indicating error(s) identified in the portion of the flyer. Responsive to receiving the errors, the online system performs remedial measure(s) to correct the identified error(s). Remedial measures may include correcting associations to items in an item catalog, modifying textual information or image data in the flyer, etc. The online system transmits the corrected flyer to client device(s) for presentation to user(s) of the online system. Such automated workflow aims to solve the technical challenges in implementation and dissemination of flyers in the online ecosystem.

### BRIEF DESCRIPTION OF THE DRAWINGS

FIG. 1A illustrates an example system environment for an online system, in accordance with one or more embodiments.

FIG. 1B illustrates an example system environment for an online system, in accordance with one or more embodiments.

FIG. 2 illustrates an example system architecture for an online system, in accordance with one or more embodiments.

FIG. 3 illustrates an example process of flyer quality assurance monitoring with a large language model, according to one or more embodiments.

FIG. 4 is a method flowchart for flyer quality assurance monitoring with a large language model, in accordance with some embodiments.

### DETAILED DESCRIPTION

### System Environment

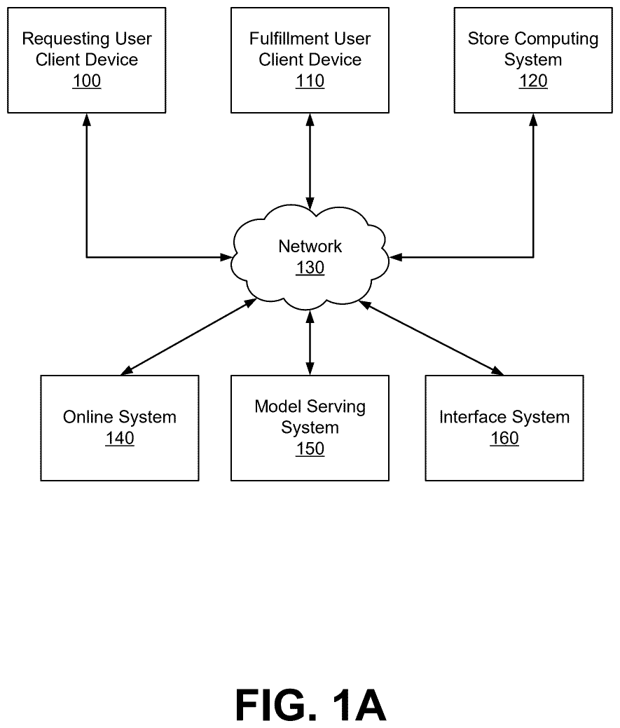

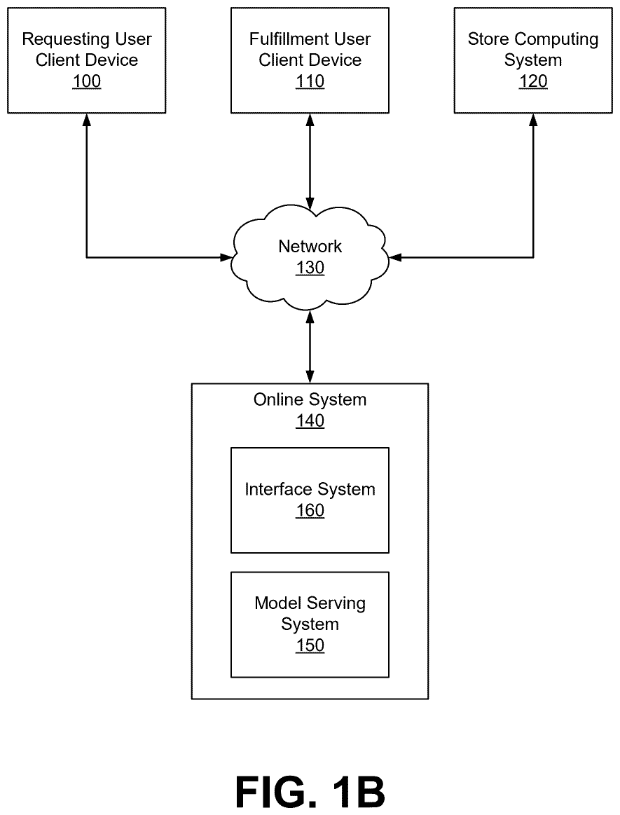

FIG. 1A illustrates an example system environment for an online system 140, in accordance with one or more embodiments. The system environment illustrated in FIG. 1A includes a requesting user client device 100, a fulfillment user client device 110, a store computing system 120, a network 130, and an online system 140. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

As used herein, requesting users, fulfillment users, and retailers may be generically referred to as “users” of the online system 140. Additionally, while one requesting user client device 100, fulfillment user client device 110, and store computing system 120 are illustrated in FIG. 1, any number of requesting users, fulfillment users, and retailers may interact with the online system 140. As such, there may be more than one requesting user client device 100, fulfillment user client device 110, or store computing system 120.

The requesting user client device 100 is a client device through which a requesting user may interact with the fulfillment user client device 110, the store computing system 120, or the online system 140. The requesting user client device 100 can be a personal or mobile computing device, such as a smartphone, a tablet, a laptop computer, or desktop computer. In some embodiments, the requesting user client device 100 executes a client application that uses an application programming interface (API) to communicate with the online system 140.

A requesting user uses the requesting user client device 100 to place an order with the online system 140. An order specifies a set of items to be delivered to the requesting user. An “item”, as used herein, means a good or product that can be provided to the requesting user through the online system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The requesting user client device 100 presents an ordering interface to the requesting user. The ordering interface is a user interface that the requesting user can use to place an order with the online system 140. The ordering interface may be part of a client application operating on the requesting user client device 100. The ordering interface allows the requesting user to search for items that are available through the online system 140 and the requesting user can select which items to add to a “shopping list.” A “shopping list,” as used herein, is a tentative set of items that the user has selected for an order but that has not yet been finalized for an order. The ordering interface allows a requesting user to update the shopping list, e.g., by changing the quantity of items, adding or removing items, or adding instructions for items that specify how the item should be collected.

The requesting user client device 100 may receive additional content from the online system 140 to present to a requesting user. For example, the requesting user client device 100 may receive coupons, recipes, or item suggestions. The requesting user client device 100 may present the received additional content to the requesting user as the requesting user uses the requesting user client device 100 to place an order (e.g., as part of the ordering interface).

Additionally, the requesting user client device 100 includes a communication interface that allows the requesting user to communicate with a fulfillment user that is servicing the requesting user's order. This communication interface allows the user to input a text-based message to transmit to the fulfillment user client device 110 via the network 130. The fulfillment user client device 110 receives the message from the requesting user client device 100 and presents the message to the fulfillment user. The fulfillment user client device 110 also includes a communication interface that allows the fulfillment user to communicate with the requesting user. The fulfillment user client device 110 transmits a message provided by the fulfillment user to the requesting user client device 100 via the network 130. In some embodiments, messages sent between the requesting user client device 100 and the fulfillment user client device 110 are transmitted through the online system 140. In addition to text messages, the communication interfaces of the requesting user client device 100 and the fulfillment user client device 110 may allow the requesting user and the fulfillment user to communicate through audio or video communications, such as a phone call, a voice-over-IP call, or a video call.

The fulfillment user client device 110 is a client device through which a fulfillment user may interact with the requesting user client device 100, the store computing system 120, or the online system 140. The fulfillment user client device 110 can be a personal or mobile computing device, such as a smartphone, a tablet, a laptop computer, or desktop computer. In some embodiments, the fulfillment user client device 110 executes a client application that uses an application programming interface (API) to communicate with the online system 140.

The fulfillment user client device 110 receives orders from the online system 140 for the fulfillment user to service. A fulfillment user services an order by collecting the items listed in the order from a retailer. The fulfillment user client device 110 presents the items that are included in the requesting user's order to the fulfillment user in a collection interface. The collection interface is a user interface that provides information to the fulfillment user on which items to collect for a requesting user's order and the quantities of the items. In some embodiments, the collection interface provides multiple orders from multiple requesting users for the fulfillment user to service at the same time from the same retailer location. The collection interface further presents instructions that the requesting user may have included related to the collection of items in the order. Additionally, the collection interface may present a location of each item in the retailer location, and may even specify a sequence in which the fulfillment user should collect the items for improved efficiency in collecting items. In some embodiments, the fulfillment user client device 110 transmits to the online system 140 or the requesting user client device 100 which items the fulfillment user has collected in real time as the fulfillment user collects the items.

The fulfillment user can use the fulfillment user client device 110 to keep track of the items that the fulfillment user has collected to ensure that the fulfillment user collects all of the items for an order. The fulfillment user client device 110 may include a barcode scanner that can determine an item identifier encoded in a barcode coupled to an item. The fulfillment user client device 110 compares this item identifier to items in the order that the fulfillment user is servicing, and if the item identifier corresponds to an item in the order, the fulfillment user client device 110 identifies the item as collected. In some embodiments, rather than or in addition to using a barcode scanner, the fulfillment user client device 110 captures one or more images of the item and determines the item identifier for the item based on the images. The fulfillment user client device 110 may determine the item identifier directly or by transmitting the images to the online system 140. Furthermore, the fulfillment user client device 110 determines a weight for items that are priced by weight. The fulfillment user client device 110 may prompt the fulfillment user to manually input the weight of an item or may communicate with a weighing system in the retailer location to receive the weight of an item.

When the fulfillment user has collected all of the items for an order, the fulfillment user client device 110 instructs a fulfillment user on where to deliver the items for a requesting user's order. For example, the fulfillment user client device 110 displays a delivery location from the order to the fulfillment user. The fulfillment user client device 110 also provides navigation instructions for the fulfillment user to travel from the retailer location to the delivery location. Where a fulfillment user is servicing more than one order, the fulfillment user client device 110 identifies which items should be delivered to which delivery location. The fulfillment user client device 110 may provide navigation instructions from the retailer location to each of the delivery locations. The fulfillment user client device 110 may receive one or more delivery locations from the online system 140 and may provide the delivery locations to the fulfillment user so that the fulfillment user can deliver the corresponding one or more orders to those locations. The fulfillment user client device 110 may also provide navigation instructions for the fulfillment user from the retailer location from which the fulfillment user collected the items to the one or more delivery locations.

In some embodiments, the fulfillment user client device 110 tracks the location of the fulfillment user as the fulfillment user delivers orders to delivery locations. The fulfillment user client device 110 collects location data and transmits the location data to the online system 140. The online system 140 may transmit the location data to the requesting user client device 100 for display to the requesting user such that the requesting user can keep track of when their order will be delivered. Additionally, the online system 140 may generate updated navigation instructions for the fulfillment user based on the fulfillment user's location. For example, if the fulfillment user takes a wrong turn while traveling to a delivery location, the online system 140 determines the fulfillment user's updated location based on location data from the fulfillment user client device 110 and generates updated navigation instructions for the fulfillment user based on the updated location.

In one or more embodiments, the fulfillment user is a single person who collects items for an order from a retailer location and delivers the order to the delivery location for the order. Alternatively, more than one person may serve the role as a fulfillment user for an order. For example, multiple people may collect the items at the retailer location for a single order. Similarly, the person who delivers an order to its delivery location may be different from the person or people who collected the items from the retailer location. In these embodiments, each person may have a fulfillment user client device 110 that they can use to interact with the online system 140.

Additionally, while the description herein may primarily refer to fulfillment users as humans, in some embodiments, some or all of the steps taken by the fulfillment user may be automated. For example, a semi- or fully-autonomous robot may collect items in a retailer location for an order and an autonomous vehicle may deliver an order to a requesting user from a retailer location.

The store computing system 120 is a computing system operated by a retailer that interacts with the online system 140. As used herein, a “retailer” is an entity that operates a “retailer location,” which is a store, warehouse, or other building from which a fulfillment user can collect items. The store computing system 120 stores and provides item data to the online system 140 and may regularly update the online system 140 with updated item data. For example, the store computing system 120 provides item data indicating which items are available at a retailer location and the quantities of those items. Additionally, the store computing system 120 may transmit updated item data to the online system 140 when an item is no longer available at the retailer location. Additionally, the store computing system 120 may provide the online system 140 with updated item prices, sales, or availabilities. Additionally, the store computing system 120 may receive payment information from the online system 140 for orders serviced by the online system 140. Alternatively, the store computing system 120 may provide payment to the online system 140 for some portion of the overall cost of a user's order (e.g., as a commission).

In one or more embodiments, the store computing system 120 provides flyers and associated data to the online system 140. For example, the store computing system 120 may provide item catalog data, promotional data, historical order data, other contextual data related to items or orders, or some combination thereof to the online system 140. The online system 140 may perform flyer quality assurance monitoring to validate the accuracy of the flyer, to provide suggested changes, to modify the flyer, or some combination thereof. In one or more embodiments, the online system 140 may perform the flyer quality assurance monitoring in an automated fashion.

The requesting user client device 100, the fulfillment user client device 110, the store computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which requesting users can order items to be provided to them by a fulfillment user from a retailer. The online system 140 receives orders from a requesting user client device 100 through the network 130. The online system 140 selects a fulfillment user to service the requesting user's order and transmits the order to a fulfillment user client device 110 associated with the fulfillment user. The fulfillment user collects the ordered items from a retailer location and delivers the ordered items to the requesting user. The online system 140 may charge a requesting user for the order and provides portions of the payment from the requesting user to the fulfillment user and the retailer.

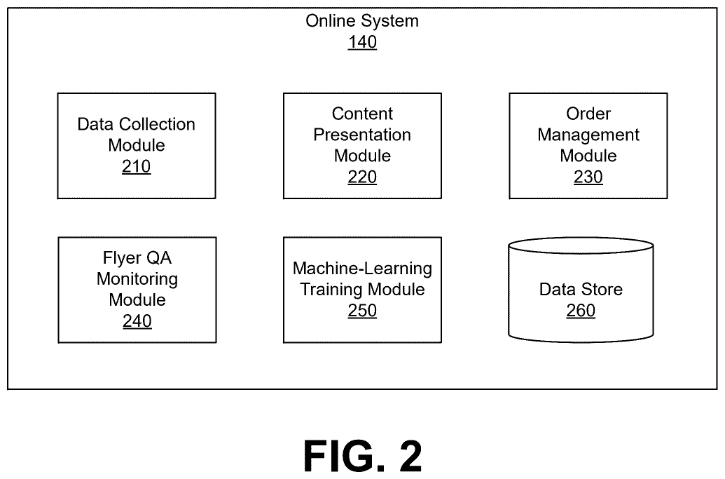

As an example, the online system 140 may allow a requesting user to order groceries from a grocery store retailer. The requesting user's order may specify which groceries they want delivered from the grocery store and the quantities of each of the groceries. The requesting user's client device 100 transmits the requesting user's order to the online system 140 and the online system 140 selects a fulfillment user to travel to the grocery store retailer location to collect the groceries ordered by the requesting user. Once the fulfillment user has collected the groceries ordered by the requesting user, the fulfillment user delivers the groceries to a location transmitted to the fulfillment user client device 110 by the online system 140. The online system 140 is described in further detail below with regards to FIG. 2.

The model serving system 150 receives requests from the online system 140 to perform inference tasks using machine-learned models. The inference tasks include, but are not limited to, natural language processing (NLP) tasks, audio processing tasks, image processing tasks, video processing tasks, and the like. In one or more embodiments, the machine-learned models deployed by the model serving system 150 are models configured to perform one or more NLP tasks. The NLP tasks include, but are not limited to, text generation, query processing, machine translation, chatbot applications, and the like. In one or more embodiments, the language model is configured as a transformer neural network architecture. Specifically, the transformer model is coupled to receive sequential data tokenized into a sequence of input tokens and generates a sequence of output tokens depending on the inference task to be performed.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many inference tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units (GPUs) for training or deploying deep neural network models. In one instance, the LLM may be trained and hosted on a cloud infrastructure service. The LLM may be trained by the online system 140 or entities/systems different from the online system 140. An LLM may be trained on a large amount of data from various data sources. For example, the data sources include websites, articles, posts on the web, and the like. From this massive amount of data coupled with the computing power of LLMs, the LLM is able to perform various inference tasks and synthesize and formulate output responses based on information extracted from the training data.

In one or more embodiments, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like. The LLM is configured to receive a prompt and generate a response to the prompt. The prompt may include a task request and additional contextual information that is useful for responding to the query. The LLM infers the response to the query from the knowledge that the LLM was trained on and/or from the contextual information included in the prompt.

In one or more embodiments, the inference task for the model serving system 150 can primarily be based on reasoning and summarization of knowledge specific to the online system 140, rather than relying on general knowledge encoded in the weights of the machine-learned model of the model serving system 150. Thus, one type of inference task may be to perform various types of queries on large amounts of data in an external corpus in conjunction with the machine-learned model of the model serving system 150. For example, the inference task may be to perform question-answering, text summarization, text generation, and the like based on information contained in the external corpus.

Thus, in one or more embodiments, the online system 140 is connected to an interface system 160. The interface system 160 receives an external corpus of data from the online system 140 and builds a structured index over the data using another machine-learned language model or heuristics. The interface system 160 receives one or more task requests from the online system 140 based on the external data. The interface system 160 constructs one or more prompts for input to the model serving system 150. A prompt may include the task request of the user and context obtained from the structured index of the external data. In one instance, the context in the prompt includes portions of the structured indices as contextual information for the query. The interface system 160 obtains one or more responses to the query from the model serving system 150 and synthesizes a response. While the online system 140 can generate a prompt using the external data as context, oftentimes, the amount of information in the external data exceeds prompt size limitations configured by the machine-learned language model. The interface system 160 can resolve prompt size limitations by generating a structured index of the data and offers data connectors to external data and provides a flexible connector to the external corpus.

In one or more embodiments, the online system 140 performs an inference task in conjunction with the model serving system 150 to perform flyer quality assurance monitoring. In one or more embodiments, the online system 140 receives a flyer (e.g., from the store computing system 120). The online system 140 generates one or more prompts to validate some portion or all of the flyer. The online system 140 may generate a prompt to verify some information in the flyer. For example, the online system 140 may generate a prompt to verify which of a plurality of brands are co-owned by one particular item manufacturer. In another example, the online system 140 may generate a prompt to verify whether an image shown in conjunction with text information is consistent with the text information. As another example, the online system 140 may generate a prompt to verify that an item from the item catalog that is associated with a promotion in the flyer is the appropriate item. In yet another example, the online system 140 may generate a prompt requesting recommendations for modifications to the flyer. The online system 140 may generate a multimodal prompt, i.e., a prompt including two or more disparate forms of information.

FIG. 1B illustrates an example system environment for an online system 140, in accordance with one or more embodiments. The system environment illustrated in FIG. 1B includes a requesting user client device 100, a fulfillment user client device 110, a store computing system 120, a network 130, and an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 and/or the interface system 160 are each managed by an entity separate from the entity managing the online system 140. In one or more embodiments, as illustrated in the example system environment in FIG. 1B, the model serving system 150 or the interface system 160 is managed and deployed by the entity managing the online system 140.

### Online System Architecture

FIG. 2 illustrates an example system architecture for an online system 140, in accordance with some embodiments. The system architecture illustrated in FIG. 2 includes a data collection module 210, a content presentation module 220, an order management module 230, a flyer quality assurance (QA) monitoring module 240, a machine-learning training module 250, and a data store 260. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 210 collects data used by the online system 140 and stores the data in the data store 260. The data collection module 210 may only collect data describing a user if the user has previously explicitly consented to the online system 140 collecting data describing the user. Additionally, the data collection module 210 may encrypt all data, including sensitive or personal data, describing users.

For example, the data collection module 210 collects requesting user data, which is information or data that describe characteristics of a requesting user. Requesting user data may include a requesting user's name, address, shopping preferences, favorite items, or stored payment instruments. The requesting user data also may include default settings established by the requesting user, such as a default retailer/retailer location, payment instrument, delivery location, or delivery timeframe. The data collection module 210 may collect the requesting user data from sensors on the requesting user client device 100 or based on the requesting user's interactions with the online system 140.

The data collection module 210 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include ordering rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a fulfillment user looked for the item but could not find it), the rate at which the item is found, or the popularity of the item. The data collection module 210 may collect item data from a store computing system 120, a fulfillment user client device 110, or the requesting user client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 210 also collects fulfillment user data, which is information or data that describes characteristics of fulfillment users. For example, the fulfillment user data for a fulfillment user may include the fulfillment user's name, the fulfillment user's location, how often the fulfillment user has services orders for the online system 140, a requesting user rating for the fulfillment user, which retailers the fulfillment user has collected items at, or the fulfillment user's previous shopping history. Additionally, the fulfillment user data may include preferences expressed by the fulfillment user, such as their preferred retailers to collect items at, how far they are willing to travel to deliver items to a requesting user, how many items they are willing to collect at a time, timeframes within which the fulfillment user is willing to service orders, or payment information by which the fulfillment user is to be paid for servicing orders (e.g., a bank account). The data collection module 210 collects fulfillment user data from sensors of the fulfillment user client device 110 or from the fulfillment user's interactions with the online system 140.

Additionally, the data collection module 210 collects order data, which is information or data that describes characteristics of an order. For example, order data may include item data for items that are included in the order, a delivery location for the order, a requesting user associated with the order, a retailer location from which the requesting user wants the ordered items collected, or a timeframe within which the requesting user wants the order delivered. Order data may further include information describing how the order was serviced, such as which fulfillment user serviced the order, when the order was delivered, or a rating that the requesting user gave the delivery of the order. In some embodiments, the order data includes user data for users associated with the order, such as requesting user data for a requesting user who placed the order or fulfillment user data for a fulfillment user who serviced the order.

In one or more embodiments, the data collection module 210 also collects communication data, which is different types of communication between shoppers and users of the online system 140. For example, the data collection module 210 may obtain text-based, audio-call, video-call based communications between different shoppers and users of the online system 140 as orders are submitted and fulfilled. The data collection module 210 may store the communication information by individual user, individual shopper, per geographical region, per subset of users having similar attributes, and the like.

In one or more embodiments, the data collection module 210 may collect data relating to user interaction with digital flyers, e.g., generated by the flyer creation module 240, automatically augmented by the flyer augmentation module 250, presented by the content presentation module 220, or some combination thereof. The data collection module 210 may measure metrics related to the user interaction such as length of time viewing the flyer, items interacted with, items added (e.g., to a shopping list, to a favorite list, or to an order), other metrics related to viewing of the digital flyer and/or interacting with items represented in the digital flyer. The data collection module 210 may also collect user feedback related to the flyer. For example, the data collection module 210 may collect information on quality issues, errors, mistaken tagging of items, difficulty parsing promotions, etc. The data collection module 210 may provide this data to the data store 260 and/or to the machine-learning training module 250 for training or tuning of one or more machine-learning models related to flyer management.

The content presentation module 220 selects content for presentation to a requesting user. For example, the content presentation module 220 selects which items to present to a requesting user while the requesting user is placing an order. The content presentation module 220 generates and transmits the ordering interface for the requesting user to order items. The content presentation module 220 populates the ordering interface with items that the requesting user may select for adding to their order. In some embodiments, the content presentation module 220 presents a catalog of all items that are available to the requesting user, which the requesting user can browse to select items to order. The content presentation module 220 also may identify items that the requesting user is most likely to order and present those items to the requesting user. For example, the content presentation module 220 may score items and rank the items based on their scores. The content presentation module 220 displays the items with scores that exceed some threshold (e.g., the top n items or the p percentile of items).

The content presentation module 220 may use an item selection model to score items for presentation to a requesting user. An item selection model is a machine-learning model that is trained to score items for a requesting user based on item data for the items and requesting user data for the requesting user. For example, the item selection model may be trained to determine a likelihood that the requesting user will order the item. In some embodiments, the item selection model uses item embeddings describing items and requesting user embeddings describing requesting users to score items. These item embeddings and requesting user embeddings may be generated by separate machine-learning models and may be stored in the data store 260.

In some embodiments, the content presentation module 220 scores items based on a search query received from the requesting user client device 100. A search query is free text for a word or set of words that indicate items of interest to the requesting user. The content presentation module 220 scores items based on a relatedness of the items to the search query. For example, the content presentation module 220 may apply natural language processing (NLP) techniques to the text in the search query to generate a search query representation (e.g., an embedding) that represents characteristics of the search query. The content presentation module 220 may use the search query representation to score candidate items for presentation to a requesting user (e.g., by comparing a search query embedding to an item embedding).

In some embodiments, the content presentation module 220 scores items based on a predicted availability of an item. The content presentation module 220 may use an availability model to predict the availability of an item. An availability model is a machine-learning model that is trained to predict the availability of an item at a retailer location. For example, the availability model may be trained to predict a likelihood that an item is available at a retailer location or may predict an estimated number of items that are available at a retailer location. The content presentation module 220 may weight the score for an item based on the predicted availability of the item. Alternatively, the content presentation module 220 may filter out items from presentation to a requesting user based on whether the predicted availability of the item exceeds a threshold.

In one or more embodiments, the content presentation module 220 receives one or more recommendations for presentation to the requesting user while the requesting user is engaged with the ordering interface. The list of ordered items of a requesting user may be referred to as a basket. As described in conjunction with FIGS. 1A and 1B, the recommendations are generated based on the inferred purpose of the basket of the requesting user and include one or more suggestions to the requesting user to better fulfill the purpose of the basket.

In one or more embodiments, the recommendations are in the form of one or more equivalent baskets that are modifications to an existing basket that serve the same or similar purpose as the original basket. The equivalent basket is adjusted with respect to metrics such as cost, healthiness, whether the basket is sponsored, and the like. For example, an equivalent basket may be a healthier option compared to the existing basket, a less expensive option compared to the existing basket, and the like. The content presentation module 220 may present the equivalent basket to the requesting user via the ordering interface with an indicator that states how an equivalent basket improves or is different from the existing basket (e.g., more cost-effective, healthier, sponsored by a certain organization). The content presentation module 220 may allow the requesting user to swap the existing basket with an equivalent basket.

In one or more embodiments, when the basket includes a list of edible ingredients, the recommendations are in the form of a list of potential recipes the ingredients can fulfill, and a list of additional ingredients to fulfill each recipe. The content presentation module 220 may present each suggested recipe and the list of additional ingredients for fulfilling the recipe to the requesting user. The content presentation module 220 may allow the requesting user to automatically place one or more additional ingredients in the basket of the requesting user.

In one or more embodiments, the content presentation module 220 may provide flyers prepared by the online system 140 to client devices for presentation to users of the online system 140. In one or more embodiments, the content presentation module 220 provides digital flyers generated by the online system 140, e.g., using a generative machine-learning model. In one or more embodiments, prior to presentation, the flyer QA monitoring module 240 performs quality assurance monitoring to verify information presented in the flyer is accurate. Once verified, the content presentation module 220 may provide the flyer to the client devices for presentation to users. With digitally-interactable flyers, as a user interacts with an item represented in the flyer, the content presentation module 220 may respond with one or more actions, e.g., maximizing a view of the item, providing additional user-interactable options (e.g., add to list, add to order, view similar items, see promotions, redeem a promotion, etc.).

The order management module 230 that manages orders for items from requesting users. The order management module 230 receives orders from a requesting user client device 100 and assigns the orders to fulfillment users for service based on fulfillment user data. For example, the order management module 230 assigns an order to a fulfillment user based on the fulfillment user's location and the location of the retailer from which the ordered items are to be collected. The order management module 230 may also assign an order to a fulfillment user based on how many items are in the order, a vehicle operated by the fulfillment user, the delivery location, the fulfillment user's preferences on how far to travel to deliver an order, the fulfillment user's ratings by requesting users, or how often a fulfillment user agrees to service an order.

In some embodiments, the order management module 230 determines when to assign an order to a fulfillment user based on a delivery timeframe requested by the requesting user with the order. The order management module 230 computes an estimated amount of time that it would take for a fulfillment user to collect the items for an order and deliver the ordered item to the delivery location for the order. The order management module 230 assigns the order to a fulfillment user at a time such that, if the fulfillment user immediately services the order, the fulfillment user is likely to deliver the order at a time within the timeframe. Thus, when the order management module 230 receives an order, the order management module 230 may delay in assigning the order to a fulfillment user if the timeframe is far enough in the future.

When the order management module 230 assigns an order to a fulfillment user, the order management module 230 transmits the order to the fulfillment user client device 110 associated with the fulfillment user. The order management module 230 may also transmit navigation instructions from the fulfillment user's current location to the retailer location associated with the order. If the order includes items to collect from multiple retailer locations, the order management module 230 identifies the retailer locations to the fulfillment user and may also specify a sequence in which the fulfillment user should visit the retailer locations.

The order management module 230 may track the location of the fulfillment user through the fulfillment user client device 110 to determine when the fulfillment user arrives at the retailer location. When the fulfillment user arrives at the retailer location, the order management module 230 transmits the order to the fulfillment user client device 110 for display to the fulfillment user. As the fulfillment user uses the fulfillment user client device 110 to collect items at the retailer location, the order management module 230 receives item identifiers for items that the fulfillment user has collected for the order. In some embodiments, the order management module 230 receives images of items from the fulfillment user client device 110 and applies computer-vision techniques to the images to identify the items depicted by the images. The order management module 230 may track the progress of the fulfillment user as the fulfillment user collects items for an order and may transmit progress updates to the requesting user client device 100 that describe which items have been collected for the requesting user's order.

In some embodiments, the order management module 230 tracks the location of the fulfillment user within the retailer location. The order management module 230 uses sensor data from the fulfillment user client device 110 or from sensors in the retailer location to determine the location of the fulfillment user in the retailer location. The order management module 230 may transmit to the fulfillment user client device 110 instructions to display a map of the retailer location indicating where in the retailer location the fulfillment user is located. Additionally, the order management module 230 may instruct the fulfillment user client device 110 to display the locations of items for the fulfillment user to collect, and may further display navigation instructions for how the fulfillment user can travel from their current location to the location of a next item to collect for an order.

The order management module 230 determines when the fulfillment user has collected all of the items for an order. For example, the order management module 230 may receive a message from the fulfillment user client device 110 indicating that all of the items for an order have been collected. Alternatively, the order management module 230 may receive item identifiers for items collected by the fulfillment user and determine when all of the items in an order have been collected. When the order management module 230 determines that the fulfillment user has completed an order, the order management module 230 transmits the delivery location for the order to the fulfillment user client device 110. The order management module 230 may also transmit navigation instructions to the fulfillment user client device 110 that specify how to travel from the retailer location to the delivery location, or to a subsequent retailer location for further item collection. The order management module 230 tracks the location of the fulfillment user as the fulfillment user travels to the delivery location for an order, and updates the requesting user with the location of the fulfillment user so that the requesting user can track the progress of their order. In some embodiments, the order management module 230 computes an estimated time of arrival for the fulfillment user at the delivery location and provides the estimated time of arrival to the requesting user.

In some embodiments, the order management module 230 facilitates communication between the requesting user client device 100 and the fulfillment user client device 110. As noted above, a requesting user may use a requesting user client device 100 to send a message to the fulfillment user client device 110. The order management module 230 receives the message from the requesting user client device 100 and transmits the message to the fulfillment user client device 110 for presentation to the fulfillment user. The fulfillment user may use the fulfillment user client device 110 to send a message to the requesting user client device 100 in a similar manner.

The order management module 230 coordinates payment by the requesting user for the order. The order management module 230 uses payment information provided by the requesting user (e.g., a credit card number or a bank account) to receive payment for the order. In some embodiments, the order management module 230 stores the payment information for use in subsequent orders by the requesting user. The order management module 230 computes a total cost for the order and charges the requesting user that cost. The order management module 230 may provide a portion of the total cost to the fulfillment user for servicing the order, and another portion of the total cost to the retailer.

The flyer quality assurance (QA) monitoring module 240 performs quality assurance monitoring of flyers, e.g., prior to presentation. In one or more embodiments, the flyers are provided by the store computing system 120. In such embodiments, the flyers may be received in digital form or scanned from a physical print of the flyer. In the digital form, the flyer may include text information describing one or more promotions, image data describing items identified in the one or more promotions, associations (or tags) to items in the item catalog identified in the one or more promotions, or some combination thereof. In a scanned form, the flyer QA monitoring module 240 may apply one or more optical character recognition models to parse text included in the flyer. The flyer QA monitoring module 240 may also apply a segmentation module to segment portions of the flyer related to text, portions of the flyer related to images of items, portions of the flyer related to background, portions of the flyer related to store information, or some combination thereof. In other embodiments, the flyers may be generated by the online system 140 (e.g., via one or more generative machine-learning models). Further description of such flyer generation leveraging generative machine-learning models may be found in U.S. patent application Ser. No. 18/677,640, filed on May 29, 2024, which is incorporated by reference in its entirety.

To perform the QA monitoring, the flyer QA monitoring module 240 generates one or more prompts for execution by a large language machine-learning model, e.g., via the model serving system 150. In one or more embodiments, the flyer QA monitoring module 240 may generate a general prompt including the flyer and a query requesting for verifying consistency in the flyer. In other embodiments, the flyer QA monitoring module 240 may generate one or more targeted prompts. In one or more embodiments, the targeted prompt may include a portion of the flyer (e.g., a promotion) and a query to verify consistency in the portion of the flyer (e.g., is the text information consistent with the image data). In one or more embodiments, the targeted prompt may be generated to verify a promotion. In one or more embodiments, the targeted prompt may be generated to verify association (i.e., tagging) of one or more items in the item catalog associated with the store (i.e., the retailer) in a promotion. The flyer QA monitoring module 240 provides the one or more prompts for execution by the large language machine-learning model. In some embodiments, the large language machine-learning model is curated (i.e., generated, refined, tuned, or some combination thereof) by the online system 140. In other embodiments, the large language machine-learning model may be stored on a separate system and executed by the model serving system 150. The large language machine-learning model may access real-time data relating to the item catalog, promotional data, or some combination thereof. The large language machine-learning model may leverage the real-time data in processing the prompts and their queries.

In one or more examples, the query in the prompt may include the following text:
“Please identify any errors or inconsistencies in the attached flyer.”
   The prompt for the above query may include the entire flyer. In other examples, the query may be targeted to verify particular information in a portion of the flyer, e.g.:
“Please verify that the caption for the promotion and the product image for the promotion are consistent.” In the above query, the prompt may include a portion of the flyer including the promotion being verified.

The flyer QA monitoring module 240 receives a response from the large language machine-learning model upon execution of the prompt. In some embodiments, the response may indicate one or more errors present in the flyer. Example errors may include mistaken inclusion of an item relating to a promotion, mistaken omission of an item relating to a promotion, inconsistency between text information and image data for a promotion, inaccurate information in the promotion, mistaken tagging or association of items in the item catalog with promotions in the flyer, other inconsistencies in the promotions presented in the flyer, or some combination thereof. In some embodiments, the large language machine-learning model may provide a confidence to each identified error (e.g., on its own accord, or in response to instructions to provide the confidence in the prompt). The flyer QA monitoring module 240 may generate a flyer accuracy score based on the responses indicating any errors present in the flyer. For example, a low flyer accuracy score may indicate many identified errors, while a high flyer accuracy score conversely indicates little to no identified errors. The flyer QA monitoring module 240 may flag any flyers with a below threshold flyer accuracy score for further review or withholding from presentation.

In one or more embodiments, the flyer QA monitoring module 240 may automatically perform flyer QA monitoring with flyers received by the online system 140, e.g., as a condition precedent to flyer presentation. The flyer QA monitoring module 240 may generate a report inclusive of any errors identified in the flyer. The report may be presented to a store computing system 120 for notification of the identified errors. In other embodiments, the flyer QA monitoring module 240 may perform flyer QA monitoring at the request of the store computing system 120, e.g., when the flyer is provided to the online system 140. In such embodiments, the flyer QA monitoring module 240 may generate a graphical user interface as a tool for performing QA of the flyers. The graphical user interface may present the verified flyer with indications to any identified errors. A user, e.g., a manager or store administrator, may interact with the graphical user interface to review the identified errors.

In one or more embodiments, the flyer QA monitoring module 240 may perform one or more remedial measures with identified errors (e.g., identified by the large language machine-learning model). In one or more embodiments, the flyer QA monitoring module 240 may generate a follow-on prompt responsive to identification of an error in the flyer. The follow-on prompt may indicate an identified error in the flyer and include a query to provide suggested corrections to remedy the error. For example, the query may include the following text:
“Please correct the text caption for the following promotion to cohere with the listed value.”

The query can be tailored to the type of error. For example, a mistaken association of items in the catalog may query for the appropriate items to be associated. In another example, if the promotion includes inaccurate information, the query may inquire into corrected information. The flyer QA monitoring module 240 may provide the follow-on prompt for execution by the large language machine-learning model, which in turn provides a response including the suggested corrections upon processing of the follow-on prompt. In some embodiments, the flyer QA monitoring module 240 may provide the suggested corrections in the user interface for viewing by the manager or administrator of the retailer.

In one or more embodiments, the flyer QA monitoring module 240 may automatically perform corrections based on the follow-on response indicating the suggested corrections. In one or more embodiments, the flyer QA monitoring module 240 may remove mistaken associations (or tagging) of items in the catalog with a promotion and add corrected associations (or tagging) of items in the catalog. In other embodiments, the flyer QA monitoring module 240 may modify portions of the flyer, e.g., replacing inaccurate text, swapping mistaken images of items for corrected images of items, inclusion of additional items related to the promotion, etc. The flyer QA monitoring module 240 may leverage a generative machine-learning model in performing such modifications.

The machine-learning training module 250 trains machine-learning models used by the online system 140. For example, the machine-learning module 230 may train the item selection model, the availability model, the large language machine-learning model, the generative machine-learning model, or any of the machine-learned models deployed by the model serving system 150. The online system 140 may use machine-learning models to perform functionalities described herein. Example machine-learning models include regression models, support vector machines, naïve bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, or transformers.

Each machine-learning model includes a set of parameters. A set of parameters for a machine-learning model are parameters that the machine-learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 250 generates the set of parameters for a machine-learning model by “training” the machine-learning model. Once trained, the machine-learning model uses the set of parameters to transform inputs into outputs.

The machine-learning training module 250 trains a machine-learning model based on a set of training examples. Each training example includes input data to which the machine-learning model is applied to generate an output. For example, each training example may include requesting user data, fulfillment user data, item data, or order data. In some cases, the training examples also include a label which represents an expected output of the machine-learning model. In these cases, the machine-learning model is trained by comparing its output from input data of a training example to the label for the training example.

The machine-learning training module 250 may apply an iterative process to train a machine-learning model whereby the machine-learning training module 250 trains the machine-learning model on each of the set of training examples. To train a machine-learning model based on a training example, the machine-learning training module 250 applies the machine-learning model to the input data in the training example to generate an output. The machine-learning training module 250 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 250 updates the set of parameters for the machine-learning model based on the score generated by the loss function. For example, the machine-learning training module 250 may apply gradient descent to update the set of parameters.

In one or more embodiments, the machine-learning training module 250 may train the large language machine-learning model used for flyer QA monitoring with annotated flyers. The annotations may include accurate flyers, flyers with errors, or some combination thereof. The annotated flyers may be provided to the large language machine-learning model to identify errors in flyers. In some embodiments, the annotations may come from an administrator or some other human reviewer. In other embodiments, the annotations may be informed from user feedback in response to engagement with the flyers. For example, requesting users may provide feedback that flyers have certain errors. The data collection module 210 may collect the feedback indicating the errors and annotate the flyers with the errors.

In some embodiments, the machine-learning training module 250 may train the large language machine-learning model with corrections to errors in flyers, to predict better suggested corrections. The data collection module 210 may record corrections (e.g., by administrators) as positive training examples. In other embodiments, the data collection module 210 may identify rejected suggested corrections as negative training examples. The machine-learning training module 250 may use these training examples to refine the large language machine-learning model's correction recommendation algorithm.

The data store 260 stores data used by the online system 140. For example, the data store 260 stores requesting user data, item data, order data, and fulfillment user data for use by the online system 140. The data store 260 also stores trained machine-learning models trained by the machine-learning training module 250. For example, the data store 260 may store the set of parameters for a trained machine-learning model on one or more non-transitory, computer-readable media. The data store 260 uses computer-readable media to store data, and may use databases to organize the stored data.

With respect to the machine-learned models hosted by the model serving system 150, the machine-learned models may already be trained by a separate entity from the entity responsible for the online system 140. In another embodiment, when the model serving system 150 is included in the online system 140, the machine-learning training module 250 may further train parameters of the machine-learned model based on data specific to the online system 140 stored in the data store 260. As an example, the machine-learning training module 250 may obtain a pre-trained transformer language model and further fine tune the parameters of the transformer model using training data stored in the data store 260. The machine-learning training module 250 may provide the model to the model serving system 150 for deployment.

### Illustrative Flowcharts

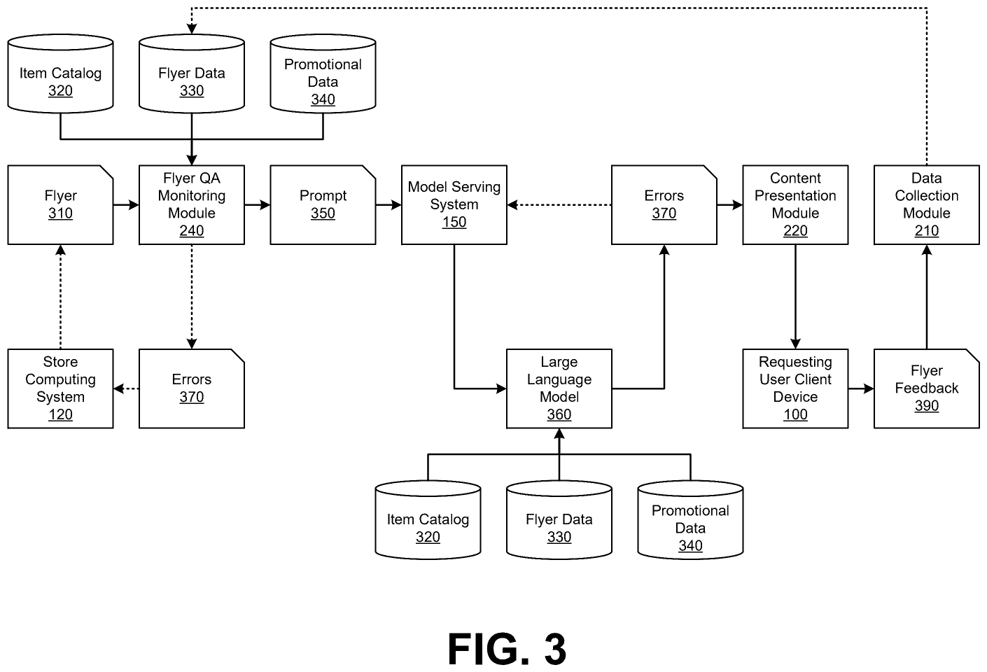

FIG. 3 illustrates an example process of flyer quality assurance (QA) monitoring, according to one or more embodiments. The example process illustrated in FIG. 3 is described as being performed by the online system 140, and its various modules and components. In other embodiments, other systems or devices may perform some or all of the steps described.

A store computing system 120 provides a flyer 310 to the online system 140. In one or more embodiments, the online system 140 may serve the flyer 310 to other users of the online system 140, to inform those users of promotions or other updates on item information available by the store, e.g., via the online system 140. In some embodiments, the store computing system 120 may request flyer QA. In other embodiments, the online system 140 may automatically perform flyer QA, e.g., as a prerequisite to presentation to users of the online system 140.

The flyer QA monitoring module 240 generates a prompt 350 for QA verification of the flyer 310. In one or more embodiments, the flyer QA monitoring module 240 may leverage data from the item catalog 320, the flyer data 330, and the promotional data 340 in crafting the prompt. For example, the flyer QA monitoring module 240 may include in the prompt particular promotions that were intended to be included. The item catalog 320 includes item data describing items available by the online system, e.g., for the various stores or retailers. The flyer data 330 includes information on current flyers, past flyers, future flyers, or some combination thereof. The information may further include metrics related to engagement with flyers or accuracy scores for past flyers. The promotional data 340 may include information describing promotions available at the various stores hosted by the online system 140. For example, the flyer QA monitoring module 240 may generate the prompt 350 to include past flyers with identified errors to inform error identification by the large language model 360. The prompt 350 may be general including the flyer 310 with a general query to identify any errors. In other embodiments, the prompt 350 may be targeted including one or more queries directed at verifying portions of the flyer 310.

The model serving system 150 provides the prompt 350 to the large language model 360 for execution. In some embodiments, the large language model 360 may access the item catalog 320, the flyer data 330, and the promotional data 340 in processing the prompt 350. The large language model 360 may leverage data in the item catalog 320, the flyer data 330, and the promotional data 340 to assess errors in the flyer 310. The large language model 360 returns any identified errors 370 in the flyer 310. The large language model 360 may return the errors 370 to the model serving system 150. In some embodiments, the flyer QA monitoring module 240 may transmit the errors to the store computing system 120 for presentation to a manager or administrator for correction. In other embodiments, the flyer QA monitoring module 240 may perform one or more remedial measures to address the identified errors 370. For example, the flyer QA monitoring module 240 may withhold the flyer 310 for presentation. In other examples, the flyer QA monitoring module 240 may modify the flyer 310 to correct the errors 370. In such embodiments, the flyer QA monitoring module 240 may leverage a generative machine-learning model to modify the flyer 310 appropriately. To leverage the generative machine-learning model, the flyer QA monitoring module 240 may generate a follow-on prompt that includes the portion of the flyer that is in error and instructions to correct the error. The prompt may be transmitted to the generative machine-learning model for execution.

Once the flyer is QA verified, the content presentation module 220 may provide the flyer 310 to the requesting user client device(s) 100 for presentation to users of the online system 140. The users may interact with the flyers 310, e.g., adding items promoted in the flyer 310 into orders. The data collection module 210 may record and collect data around user engagement with the flyer 310. The user engagement can indicate hot spots on the flyer, favorably-received promotions, overlooked promotions, other metrics relating to flyer engagement, or some combination thereof. The users, via their requesting user client device 100, may further provide flyer feedback 390 to the data collection module 210. The flyer feedback 390 may indicate whether the flyer was error-free or had some errors. The training module 250 may leverage the flyer feedback 390 to train the large language model 360 to improve error identification, suggested corrections, or some combination thereof.

### Example Methods

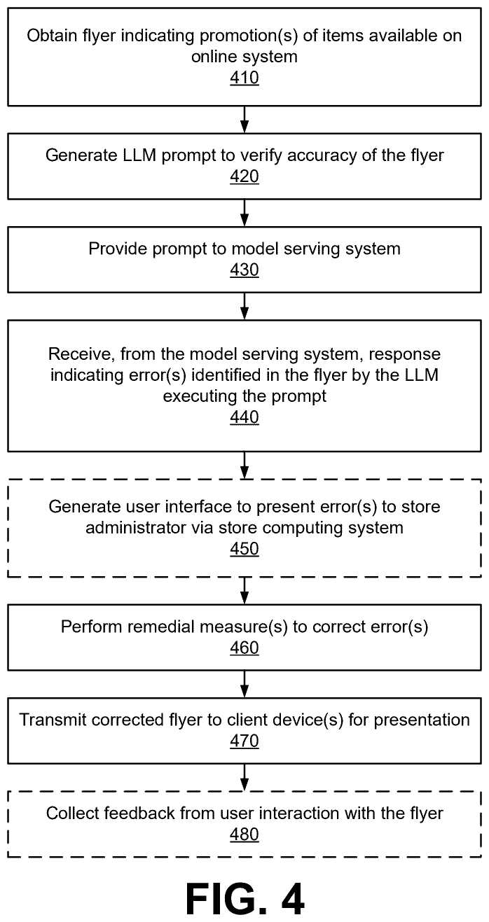

FIG. 4 is a method flowchart for performing flyer quality assurance (QA) monitoring to identify and remedy errors in flyers, in accordance with some embodiments. Alternative embodiments may include more, fewer, or different steps from those illustrated in FIG. 4, and the steps may be performed in a different order from that illustrated in FIG. 4. These steps may be performed by an online system (e.g., online system 140). Additionally, each of these steps may be performed automatically by the online system without human intervention.

The online system 140 obtains 410 a flyer indicating one or more promotions of items available on an online system. The flyer may be generated by a store computing system promoting items available at the store's in-person location. In some embodiments, the online system 140 may receive the flyer in a digital format from the store computing system. In other embodiments, the online system 140 may scan a physical print of the flyer. The online system 140 may perform image segmentation, optical character recognition, item matching, or other processing techniques on the scanned flyer. In other embodiments, the flyer may be generated via a generative machine-learning model implemented by the online system 140.

The online system generates 420 a prompt to verify accuracy of the flyer. The prompt may include at least a portion of the flyer and a query to identify errors in that portion. In some embodiments, the online system may generate a general prompt including the whole flyer and a general query to identify errors. In other embodiments, the online system may generate one or more targeted prompts including portions of the flyer and targeted queries to verify different bits of information represented in the flyer.

The online system provides 430 the prompt to a model serving system for execution by the large language machine-learning model. The online system receives 440, from the model serving system, a response indicating one or more errors identified in the flyer by the large language machine-learning model executing the prompt. The errors may further be categorized. The response from the large language machine-learning model may also indicate a confidence to the errors identified.

The online system may generate 450 a user interface to present the identified errors as a tool for an administrator of a store computing system to review and correct the errors. The administrator via the store computing system may review the errors and provide modifications to correct the errors. In some embodiments, the online system may also provide suggested corrections. The suggested corrections may be identified by re-prompting the large language machine-learning model.

The online system performs 460 remedial measures to correct the errors identified in the flyer. Remedial measures may include correcting associations to items in an item catalog, modifying textual information or image data in the flyer, etc. In embodiments with the user interface, the administrator may provide input, via the store computing system, on which remedial measures to undertake. In other embodiments, the online system may automatically perform such remedial measures.

The online system transmits 470 the corrected flyer to client device(s) for presentation to user(s) of the online system. In some embodiments, the flyer may be digitally interactable. The user may interact with user-interactable elements on the flyer, e.g., to perform one or more actions in conjunction with items promoted in the flyer. For example, the user-interactable element may include an association to items in the item catalog represented in the flyer. The user may click on the user-interactable element, which may trigger one or more actions that may be performed in conjunction with the associated items (e.g., add to order, favorite, add to a list, etc.).

In some embodiments, the online system collects 480 feedback describing the user interaction with the flyer. The feedback may provide insight into the error identification accuracy by the large language machine-learning model. If there are any missed errors, the online system may leverage the missed errors to fine-tune or retrain the large language machine-learning model to improve error identification. The feedback may also provide insight into the remedial measures undertaken to correct identified errors. For example, if an added association to a promotion was invalid or inaccurate, then the online system may leverage such insight in fine-tuning or retraining the large language machine-learning model to improve correction recommendation.

### Additional Considerations

The foregoing description of the embodiments has been presented for the purpose of illustration; many modifications and variations are possible while remaining within the principles and teachings of the above description. Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated for the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, performed at a computer system comprising a processor and a computer-readable medium, comprising:
obtaining a flyer indicating one or more promotions of items available on an online system;
generating a prompt for a large language machine-learning model to verify accuracy of the flyer, wherein the prompt comprises at least a portion of the flyer and a query to identify errors in at least the portion of the flyer;
providing the prompt to a model serving system for execution by the large language machine-learning model;
receiving, from the model serving system, a response indicating one or more errors identified in the portion of the flyer by executing the large language machine-learning model on the prompt;
responsive to receiving the response indicating the one or more errors identified in the portion of the flyer, performing one or more remedial measures to correct the flyer by fixing one or more errors identified in the portion of the flyer; and
transmitting the corrected flyer to one or more client devices for presentation to users of the online system, wherein the transmitting causes the one or more client devices to display the corrected flyer.

2. The computer-implemented method of claim 1, further comprising:
performing image segmentation to segment the flyer into one or more segments relating to text information for promotions and one or more segments relating to image data for the promotions; and
performing an optical character recognition algorithm on the one or more segments relating to text information to parse the text information.

3. The computer-implemented method of claim 1, wherein generating the prompt comprises:
generating the prompt including the query to verify if text information in the portion of the flyer is consistent with image data in the portion of the flyer.

4. The computer-implemented method of claim 1, wherein the flyer is digitally interactable, and wherein generating the prompt comprises:
generating the prompt including the query to verify if an associated item in an item catalog is consistent with a promotion presented in the portion of the flyer.

5. The computer-implemented method of claim 1, wherein generating the prompt comprises:
generating the prompt further including instructions to provide a confidence in the one or more errors identified,
wherein the response from the model serving system indicates the confidence in the one or more errors identified.

6. The computer-implemented method of claim 1, wherein performing the one or more remedial measures comprises:
generating a user interface visually depicting the flyer and the one or more identified errors;
transmitting the user interface to a store computing system for presentation to an administrator of an associated store; and
receiving one or more modifications to the flyer from the store computing system to correct the one or more errors identified.

7. The computer-implemented method of claim 6, wherein performing the one or more remedial measures further comprises:
generating a follow-on prompt including the one or more identified errors in the portion of the flyer and a follow-on query to recommend one or more modifications to the flyer;
providing the follow-on prompt to the model serving system for execution by the large language machine-learning model;
receiving, from the model serving system, a subsequent response indicating the one or more modifications to the flyer to correct the one or more errors by executing the large language machine-learning model on the follow-on prompt; and
generating the user interface to recommend the one or more modifications to the flyer.

8. The computer-implemented method of claim 1, wherein performing the one or more remedial measures further comprises:
generating a follow-on prompt including the one or more identified errors in the portion of the flyer and a follow-on query to recommend one or more modifications to the flyer;
providing the follow-on prompt to the model serving system for execution by the large language machine-learning model;
receiving, from the model serving system, a subsequent response indicating the one or more modifications to the flyer to correct the one or more errors by executing the large language machine-learning model on the follow-on prompt; and
modifying the portion of the flyer according to the one or more modifications in the subsequent response.

9. The computer-implemented method of claim 8, wherein modifying the portion of the flyer comprises:
applying a generative machine-learning model to modify the flyer according to the one or more modifications.

10. The computer-implemented method of claim 1, wherein performing the one or more remedial measures further comprises one or both of:
removing an association to a first item that is mistakenly associated with the portion of the flyer; and
adding an association to a second item that is mistakenly omitted from association with the portion of the flyer.

11. The computer-implemented method of claim 1, wherein the large language machine-learning model is trained by:
receiving historical feedback from one or more client devices indicating one or more errors in one or more flyers presented to users of the online system;
generating a plurality of training examples indicating the one or more errors in the one or more flyers; and
training the large language machine-learning model with the plurality of training examples to identify errors in flyers.

12. The computer-implemented method of claim 1, further comprising:
receiving feedback from the one or more client devices indicating one or more missed errors in the flyer presented to the users of the online system;
generating a negative training example indicating the one or more missed errors in the flyer; and
training the large language machine-learning model with the negative training example to improve error identification.

13. A non-transitory computer-readable storage medium storing instructions that, when executed by a computer processor, cause the computer processor to perform operations comprising:
obtaining a flyer indicating one or more promotions of items available on an online system;
generating a prompt for a large language machine-learning model to verify accuracy of the flyer, wherein the prompt comprises at least a portion of the flyer and a query to identify errors in at least the portion of the flyer;
providing the prompt to a model serving system for execution by the large language machine-learning model;
receiving, from the model serving system, a response indicating one or more errors identified in the portion of the flyer by executing the large language machine-learning model on the prompt;
responsive to receiving the response indicating the one or more errors identified in the portion of the flyer, performing one or more remedial measures to correct the flyer by fixing one or more errors identified in the portion of the flyer; and
transmitting the corrected flyer to one or more client devices for presentation to users of the online system, wherein the transmitting causes the one or more client devices to display the corrected flyer.

14. The non-transitory computer-readable storage medium of claim 13, the operations further comprising:
performing image segmentation to segment the flyer into one or more segments relating to text information for promotions and one or more segments relating to image data for the promotions; and
performing an optical character recognition algorithm on the one or more segments relating to text information to parse the text information.

15. The non-transitory computer-readable storage medium of claim 13, wherein generating the prompt comprises:
generating the prompt including the query to verify if text information in the portion of the flyer is consistent with image data in the portion of the flyer.

16. The non-transitory computer-readable storage medium of claim 13, wherein the flyer is digitally interactable, and wherein generating the prompt comprises:
generating the prompt including the query to verify if an associated item in an item catalog is consistent with a promotion presented in the portion of the flyer.

17. The non-transitory computer-readable storage medium of claim 13, wherein generating the prompt comprises:
generating the prompt further including instructions to provide a confidence in the one or more errors identified,
wherein the response from the model serving system indicates the confidence in the one or more errors identified.

18. The non-transitory computer-readable storage medium of claim 13, wherein performing the one or more remedial measures comprises:
generating a user interface visually depicting the flyer and the one or more identified errors;
transmitting the user interface to a store computing system for presentation to an administrator of an associated store; and
receiving one or more modifications to the flyer from the store computing system to correct the one or more errors identified.

19. The non-transitory computer-readable storage medium of claim 13, the operations further comprising:
receiving feedback from the one or more client devices indicating one or more missed errors in the flyer presented to the users of the online system;
generating a negative training example indicating the one or more missed errors in the flyer; and
training the large language machine-learning model with the negative training example to improve error identification.

20. A computing system comprising:
a computer processor; and
a non-transitory computer-readable storage medium storing instructions that, when executed by the computer processor, cause the computer processor to perform operations comprising:
obtaining a flyer indicating one or more promotions of items available on an online system;
generating a prompt for a large language machine-learning model to verify accuracy of the flyer, wherein the prompt comprises at least a portion of the flyer and a query to identify errors in at least the portion of the flyer;
providing the prompt to a model serving system for execution by the large language machine-learning model;
receiving, from the model serving system, a response indicating one or more errors identified in the portion of the flyer by executing the large language machine-learning model on the prompt;
responsive to receiving the response indicating the one or more errors identified in the portion of the flyer, performing one or more remedial measures to correct the flyer by fixing one or more errors identified in the portion of the flyer; and
transmitting the corrected flyer to one or more client devices for presentation to users of the online system, wherein the transmitting causes the one or more client devices to display the corrected flyer.
